(19) United States
(12) Patent Application Publication
(10) Pub. No.: US 2007/0271446 A1
(43) Pub. Date: Nov. 22, 2007

(54) Application Execution Device and Application Execution Device Application Execution Method

(76) Inventor: Tomonori Nakamura, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/632,418

(22) PCT Filed: Jul. 14, 2005
(86) PCT No.: PCT/JP05/13069

§ 371 Date: Jun. 15, 2007

(30) Foreign Application Priority Data
Jul. 16, 2004 (JP) 2004-210764

(51) Int. Cl. G06F 9/44

(52) U.S. Cl. 712/226

(57) ABSTRACT

The conventional application protection technique complicates an application to make it difficult to analyze the application. However, with such a complication method, the complicate program can be analyzed sooner or later by taking a lot of time no matter how the degree of the complication is high. Also, it is impossible to protect the application from unauthorized copying. The meta-information managing unit that is to be executed in the secure execution unit stores the meta-information of the application in an area that can not be accessed by a debugger. When the meta-information is required by the normal execution unit to execute the application, a result of predetermined calculation using the meta-information is notified to the normal execution unit. In this way, the meta-information of the application can be kept secret.

### TECHNICAL FIELD

The present invention relates to an application execution device for executing an application program (especially a program written in the Java™ language), and a technique to protect an application program against wiretapping and tampering when the application execution device executes an application downloaded from the Internet or an external medium such as a DVD.

### BACKGROUND ART

An increasing number of conventional electronic devices such as digital TVs and mobile phones have a function to download an application program written in Java™ language and execute the application. Regarding mobile phones for example, NTT DoCoMo provides a service called i-Appli™. In this service, a mobile phone downloads a Java™ program from an application distribution server on the Internet, and executes the program.

In Europe, specifications called DVB-MHP (Digital Video Broadcasting-Multimedia Home Platform) has been defined, and now it is being operated based on the specifications. In digital broadcasting based on the DVB-MHP standard, a digital TV receives a Java™ program multiplexed into a broadcast wave, and executes the program.

In such an application program distribution service, the application program should be protected against wiretapping by malicious attackers, based on the intellectual property right of the developer of the application. Also, it is necessary to prevent an application program tampered by malicious attackers from operating in a manner not intended by the user or the developer.

Electronic devices of recent years are structured with many software modules. It is possible for a person having specialized knowledge to tamper the software inside an electronic device by abusing bugs of the software modules. Also, the same is possible with use of tools such as a debugger and an ICE (In-Circuit Emulator). Therefore, in the case where a Java™ program includes a copyright managing function or a charging function for example, such functions can be disabled. This is a problem. With development of Java™ application program distribution business, it is concerned that the problem of wiretapping and tampering of such an application program becomes more serious.

Conventionally, to prevent abuse of bugs of a software module, and analysis and tampering of a program on a memory using a tool such as a debugger and an ICE, a complication method and an encryption method are performed on an original program.

The complication method is for converting a program to a more complicate program that operates in the same manner as the original program by dividing the processes, shuffling the processes, inserting conditions and so on. The encryption method is for encrypting the program and decrypting the encrypted program only when executing the program.

Patent Document 1: Japanese Patent Publication No. 2002-514333

### DISCLOSURE OF THE INVENTION

### Problem to be Solved by the Invention

However, regarding the complication method, the complicate program can be analyzed sooner or later by taking a lot of time no matter how the degree of the complication is high. If the value of the application program is high, it is impossible to prevent appearance of people who pay a high cost to analyze the application program.

Also, regarding the encryption method, since the program is decrypted while it is executed, it is possible that the program is analyzed while it is executed.

The object of the present invention is to solve the above-described problem. For this object, the present invention provides an application execution device that can protect an application program against wiretapping and tampering by abusing bugs of software modules, using a specialized tool, and so on.

### Means for Solving the Problem

To solve the above-described problem, the present invention provides an application execution device that executes each of classes included in an acquired application, comprising: a meta-information storing unit operable to store meta-information included in a class file; an instruction sequence storing unit operable to store an instruction sequence included in the class file; an instruction execution unit operable (i) to execute an instruction if the instruction does not refer to any information, and (ii) if the instruction refers to first information, to submit a request and execute the instruction using second information provided in response to the request; and a meta-information execution unit operable to generate the second information based on the meta-information in response to the request, and provide the instruction execution unit with the second information, wherein only the meta-information execution unit is capable of reading the meta-information stored in the meta-information storing unit, and the meta-information execution unit accepts only a request from the instruction execution unit.

### ADVANTAGEOUS EFFECTS OF THE INVENTION

With the stated structure, if there is information to be referred, the instruction execution unit that executes instruction of the application instructs the meta-information execution unit and receives the second information that is necessary information. Therefore, it is impossible for the third party to see the meta-information stored in the meta-information storing unit, even if the third party wire taps the instruction execution unit by a debugger, for example. It is difficult to analyze the application by wiretapping or tampering the instruction sequence in the instruction execution unit, and it is possible to protect the application against wiretapping and tampering.

The meta-information storing unit may store a constant pool describing an index, a constant pool type and a value, and a class structure information describing an item and a value, the instruction sequence storing unit may store a bytecode of a method defined in the class file, and if the instruction execution unit executes an instruction included in a bytecode that designates the index of the constant pool as the first information, the meta-information execution unit may generate the second information with reference to the constant pool and the class structure information, in accordance with a type of the instruction.

With this structure, the protection level is heightened, and it is possible to protect the application against analysis and tampering even during the execution of the application.

If the bytecode to be executed by the instruction execution unit represents a generation of a new object, the meta-information execution unit may search for a constant pool type corresponding to the designated index from the constant pool, and generate a memory size with reference to the class structure information.

With this structure, the instruction execution unit acquires the object size. However, the number of fields and the type descriptor declared in the class, based on which the object size has been calculated, can not seen from the instruction execution unit.

If the bytecode to be executed by the instruction execution unit represents a call of the method, the meta-information execution unit may search for a constant pool type corresponding to the designated index from the constant pool, and generate an address of the method with reference to the class structure information.

With this structure, the instruction execution unit acquires the address of the method. However, the meta-information required for acquiring the address cannot be seen from the instruction execution unit.

If the bytecode to be executed by the instruction execution unit represents a reference to a field of an object, the meta-information execution unit may search for a constant pool type corresponding to the designated index from the constant pool, and generate an address of the field with reference to the class structure information.

With this structure, the instruction execution unit acquires the address of the field. However, the meta-information required for acquiring the address cannot be seen from the instruction execution unit.

The acquired application may be encrypted, and the application execution device may further comprise a decryption unit operable to decrypt the encrypted application, store decrypted instruction sequence in the instruction sequence storing unit, and store decrypted meta-information in the meta-information storing unit.

With this structure, the protection level is heightened, and it becomes possible to protect the meta-information of the application at the time of the decryption of the application.

The decryption unit may use a decryption key to decrypt the application, the decryption key being stored in a key storing unit that does not accept a direct access from outside.

With this structure, the protection level is heightened, and it becomes possible to protect the application against analysis and tampering due to unauthorized decryption.

The application may be a Java™ application.

With this structure, it becomes possible to protect the Java™ application against the wiretapping and tampering.

The present invention also provides An application execution method used by an application execution device that executes each of classes included in an acquired application, the method comprising: a meta-information storing step of storing meta-information included in a class file; an instruction sequence storing step of storing an instruction sequence included in the class file; an instruction execution step of (i) executing an instruction if the instruction does not refer to any information, and (ii) if the instruction refers to first information, submitting a request and executing the instruction using second information provided in response to the request; and a meta-information execution step of generating the second information based on the meta-information in response to the request, and providing the instruction execution step with the second information, wherein only the meta-information execution step is capable of reading the meta-information stored by the meta-information storing step, and the meta-information execution step accepts only a request from the instruction execution step.

With the stated method, it becomes impossible for a tool such as a debugger to access the meta-information of the application, even if the instruction of the application is wiretapped and tampered on the memory by the tool while the application is executed. Therefore, this makes analysis of the application difficult, and protects the application against wiretapping and tampering.

### BRIEF DESCRIPTION OF THE DRAWINGS

FIG. 1 shows a structure of an application execution device according to the first embodiment of the present invention;

FIG. 2 shows a Java™ virtual machine according to the first embodiment;

FIG. 3 shows a structure of a Java™ class file according to the first embodiment;

FIG. 4 shows an example structure of information stored in the first ROM according to the first embodiment;

FIG. 5 shows an example structure of an application acquisition program according to the first embodiment;

FIG. 6 is a flowchart showing procedures for processing meta-information according to the first embodiment;

FIG. 7 shows an example structure of information stored in the second ROM according to the first embodiment;

FIG. 8 is a flowchart showing procedures for loading the Java™ virtual machine according to the first embodiment;

FIG. 9 is a flowchart showing procedures for decryption according to the first embodiment;

FIG. 10 is a flowchart showing procedures for loading a class according to the first embodiment;

FIG. 11 shows an example of a Java™ class according to the first embodiment;

FIG. 12 shows an example of a constant pool according to the first embodiment;

FIG. 13 shows an example of class structure information set according to the first embodiment.

FIG. 14 shows an example of a bytecode according to the first embodiment;

FIG. 15 is a flowchart showing procedures for processing a new instruction of the bytecode according to the first embodiment;

FIG. 16 shows an example of a class ID correspondence table according to the first embodiment;

FIG. 17 shows another example of the class ID correspondence table according to the first embodiment;

FIG. 18 is a flowchart of operations performed by a bytecode interpreter and a meta-information managing unit for executing an invokespecial instruction according to the first embodiment;

FIG. 19 is a flowchart of operations performed by the bytecode interpreter and the meta-information managing unit for executing a getfield instruction according to the first embodiment;

FIG. 20 shows a structure of an application execution device according to the second embodiment of the present invention;

FIG. 21 shows a structure of a virtual machine according to the second embodiment of the present invention;

FIG. 22 shows an example structure of information stored in the first ROM according to the second embodiment; and

FIG. 23 is a flowchart showing procedures for loading the Java™ virtual machine according to the second embodiment

### EXPLANATION OF REFERENCES

100, 2000 downloadable program
110, 2010 application execution device
120, 2020 normal execution unit
121, 2021 application acquisition program
122 Java™ virtual machine
123, 2023 OS
124, 2024 first CPU
125, 2025 first RAM
126, 2026 first ROM
130, 2030 secure execution unit
131, 2031 meta-information managing unit
132, 2033 Java™ virtual machine loader
133, 2034 decryption unit
134, 2035 second CPU
135, 2036 second RAM
136, 2037 second ROM
201, 2101 bytecode interpreter
202, 2106 class loader
203, 2107 verifier
204, 2103 Java™ heap managing unit
205, 2104 Java™ native library
206, 2105 JIT compiler
300 class file
301 class structure information set
302 constant pool
303 bytecode
401 encrypted Java™ virtual machine
402 encrypted application acquisition program
403 encrypted meta-information managing unit
404 startup class name
501 encrypted subclass
701 encryption key
1100 class definition file written in Java™ language
1600 class correspondence table (example 1)
1700 class correspondence table (example 2)
2022 first Java™ virtual machine
2032 second Java™ virtual machine

### BEST MODE FOR CARRYING OUT THE INVENTION

The following describes the embodiments of the application execution device according to the present invention, with reference to the drawings.

### The First Embodiment

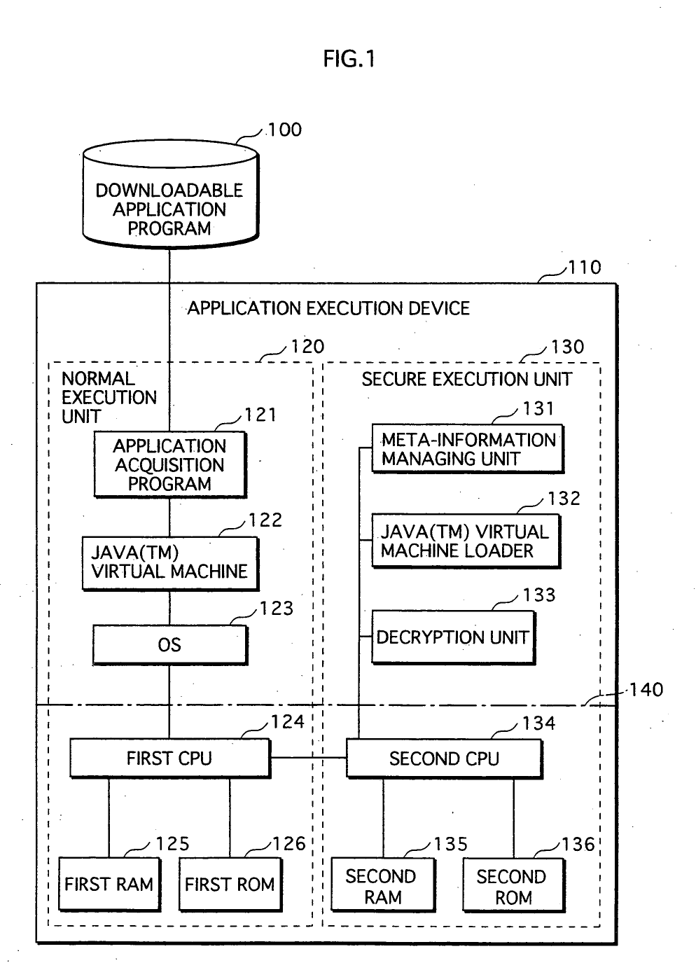

FIG. 1 shows a structure of an application execution device according to the first embodiment of the present invention.

A downloadable application program (hereinafter called “an application”) 100 is an application that is downloadable by the application execution device 110. In this embodiment, the application 100 is a Java™ application that has been compiled and encrypted.

The application execution device 110 includes a normal execution unit 120 and a secure execution unit 130, and structured with software above a virtual line 140 and hardware below the virtual line 140. The application execution device 110 is applied to an electronic device and a terminal device in which a Java™ virtual machine is incorporated, such as a digital TV, a set-top box, a DVD recorder, a Blu-ray Disc (BD) recorder, a car navigation system, a mobile phone and a PDA.

The normal execution unit 120 includes, as software, an application acquisition program 121, a Java™ virtual machine 122 and an OS 123, and as hardware, a first CPU 124, a first RAM 125 and a first ROM 126. Here, the application acquisition program 121, the Java™ virtual machine 122 and the OS 123 form a software layer structure and arranged in this order from top to bottom. These pieces of software are executed by the first CPU 124.

The normal execution unit 120 is the same as a common program execution unit mounted in a personal computer, a digital appliance, and the likes. Note that the program execution unit 120 in the Claims includes an instruction execution unit and an instruction sequence storing unit.

The secure execution unit 130 includes, as software, a meta-information managing unit 131, a Java™ virtual machine loader 132, a decryption unit 133, and as hardware, a second CPU 134, a second RAM 135 and a second ROM 136. Here, the pieces of software, namely the meta-information managing unit 131, the Java™ virtual machine loader 132 and the decryption unit 133, are executed by the second CPU 134.

The secure execution unit 130 is capable of protect a program against tampering by a malicious third party, while securely executing the program. In other words, an external device is prohibited to directly access the secure execution unit 130, and the second CPU 134 transmits required information to the first CPU 124 in accordance with an instruction from the first CPU 124. Note that the secure execution unit 130 in the Claims includes a meta-information execution unit, a meta-information storing unit and a decryption unit.

Firstly, the components of the normal execution unit 120 are described below.

The application acquisition unit 121 acquires the application 100 from outside the application execution device 110, and stores the application 100 in the first RAM 125. The application acquisition program 121 is a Java™ program that downloads the Java™ application 100 (encrypted, in the class file format) from a server on the Internet for example, in conformity with protocols such as TLS (Transport Layer Security), HTTP (Hyper Text Transfer Protocol), and so on.

The TLS is a data transmission method that uses encryption to protect data against wiretapping and tampering during the communication. The details of the TLS are described in the RFC2246. Therefore, the explanation thereof is omitted here.

The HTTP is a data transmission method commonly used for data communications on the Internet. The details of the HTTP are described in the RFC2616. Therefore, the explanation thereof is omitted here.

Note that the application acquisition program 121 may be a Java™ program that reads, into the application execution unit 110, a Java™ application embedded in a MPEG2 transport stream as data broadcast by digital broadcasting. The details of the MPEG2 transport stream is described in the MPEG Specifications ISO/IEC 138181-1. Therefore, the explanation thereof is omitted here. A method for embedding a Java™ program into a MPEG2 transport stream, namely a DSMCC method, is described in the MEPG Specifications SIO/IEC 138181-6. Therefore, the explanation thereof is omitted here. The DSMCC method defines a method for encoding a file system structured with directories and files used by a computer and embedding it in packets of a MPEG2 transport stream.

Also, the application acquisition program 121 may be a Java™ program that writes, into the first RAM 125, a Java™ application recorded on a removable medium such as a SD card, a CD-ROM, a DVD, a BD-ROM, or the like. The application acquisition program 121 uses a file operation function provided by the OS 123 to read the Java™ application from the removable medium.

Also, the application acquisition program 121 may be a Java™ program that writes, into the first RAM 125, a Java™ application stored in the first ROM in the application execution device 110. The application acquisition program 121 uses the file operation function provided by the OS 123 to read the Java™ application from the first ROM 126.

In this embodiment, the application acquisition program 121 is a Java™ program written in the Java™ language. However, the application acquisition program 121 may be a program written in native language (that is unique to the execution device) having the same function as the Java™ program.

The Java™ virtual machine 122 sequentially analyzes and executes a program written in the Java™ language. The program written in Java™ language is to be compiled to bytecodes as intermediate codes (operations), namely an instruction sequence independent from hardware. The Java™ virtual machine 122, is realized as software that interprets and executes the bytecodes. The Java™ virtual machine 122 may have a function called a JIT (Just In Time) compiler for translating the bytecodes into object codes executable by the first CPU 124. Also, the Java™ virtual machine 122 may includes a processor that is capable of directly executing some of the bytecodes, and an interpreter that is capable of executing the rest of the bytecodes that the processor cannot execute. The details of the Java™ language are explained in many books such as “Java™ Language Specification (ISBN 0-201-63451-1)”. Therefore, the explanation thereof is omitted here.

The Java™ virtual machine 122 includes a plurality of subprograms.

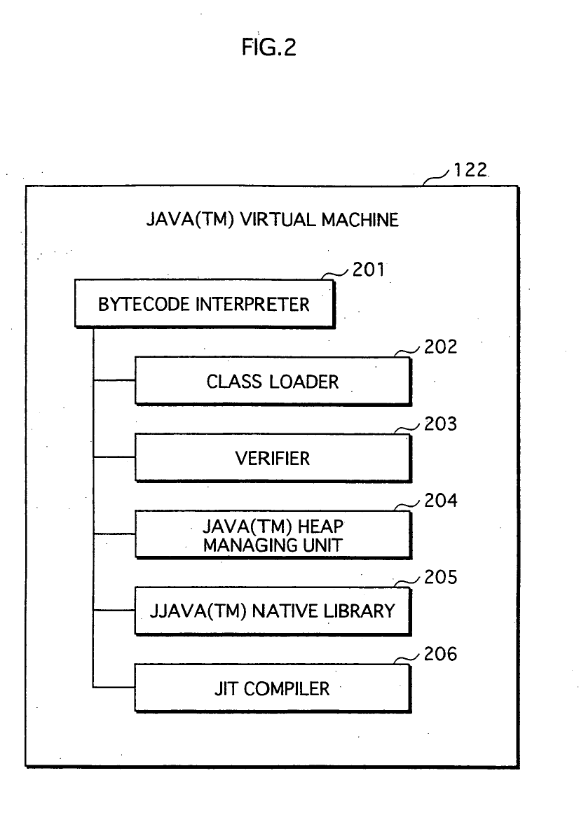

FIG. 2 shows an example of subprograms included in the Java™ virtual machine 122. As FIG. 2 shows, the Java™ virtual machine 122 includes a bytecode interpreter 201, a class loader 202, a verifier 203, a Java™ heap managing unit 204, a Java™ native library 205 and a JIT compiler 206.

The bytecode interpreter 201 is a subprogram that interprets and executes bytecodes included in a class file, and performs core processing in the Java™ virtual machine 122. The details thereof are explained later.

The class loader 202 reads, from the first RAM 125, the Java™ application 100 acquired by the application acquisition program 121, and converts the read application 100 to an application executable by the Java™ virtual machine 122. Then, the class loader 202 writes the resultant application into the RAM 125 so that the class is executable. The class loader 202 also performs class unloading. The class unloading is performed to remove an executed unnecessary class from the Java™ virtual machine 122.

Here, the class is a base unit for structuring the Java™ application, and defined in the book “Java™ Virtual Machine Specification (ISBN 0-201-63451-1)”.

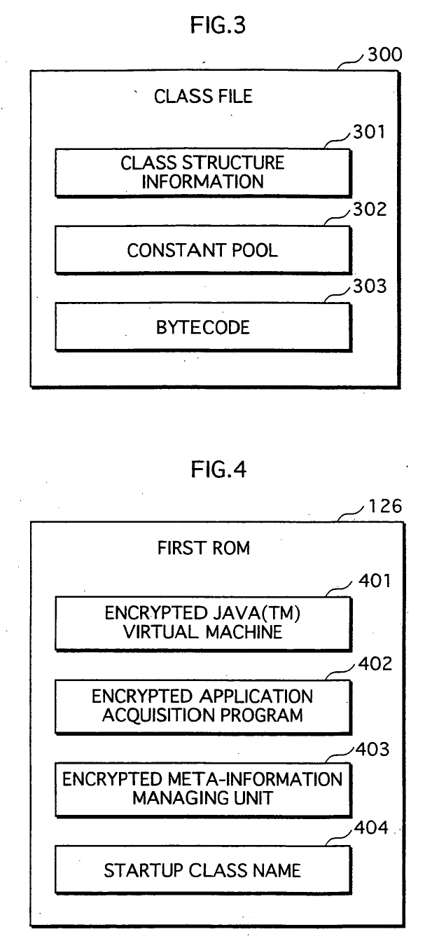

FIG. 3 schematically shows pieces of information included in a class file.

The definition in “Java™ Virtual Machine Specification (ISBN 0-201-63451-1)” includes other information that is not shown in FIG. 3. However, only information relating to the present invention is explained in the following, for simplification.

A class structure information set 301 includes information relating to the structure of the class, such as field and method of the class, and which class is to be inherited by the class.

A constant pool 302 is a group of data relating to a constant defined in the application (class), and includes field names, method names and class names defined in the class or other class referred to by the class. The class structure information set 301 and the constant pool 302 are collectively called “meta-information of a class” or simply “meta-information”.

The bytecode 303 describes processing of a method executed in the class, as an instruction sequence in intermediate language. The byte code 303 does not include information of data to be processed by the application. Accordingly, it is generally impossible to execute the Java™ application by using only the bytecode 303. The Java™ application is executable only with the constant pool defining the data part. The information included in the class is described later.

In FIG. 2, the verifier 203 judges a defect of a data format of the class and security of the bytecode included in the class. Examination of the security of the bytecode is defined in the Java™ Virtual Machine Specification. Therefore, detailed explanation thereof is omitted here.

If the verifier 203 judges that the class is not appropriate, the class loader 202 does not load the class.

The Java™ heap managing unit 204 secures a Java™ heap, which is a working memory to be used by the Java™ application. The Java™ heap is secured in the first RAM 125. The Java™ heap managing unit 204 also performs garbage collection. The garbage collection is to release an unnecessary working memory so that it can be used for another purpose again. This technique is well-known. Therefore, the detailed explanation is omitted here.

The Java™ native library 205 is a library called by the Java™ application. The Java™ native library 205 provides the Java™ application with functions provided by the OS 123 and hardware and subprograms that are not illustrated in FIG. 1 but included in the application execution device 110.

The JIT compiler 206 translates the bytecode 303 to an object program that is executable by the first CPU 124 or the second CPU 134.

This completes the schematic explanation of the Java™ virtual machine 122 based on FIG. 2.

Again, in FIG. 1, the OS 123 is an operating system with which the first CPU 124 is started up when the application execution device 110 is powered on. The OS 123 is an operating system, such as the Linux. The operating system is a generic name for well-known techniques including a kernel for executing programs in parallel, and libraries. The detailed explanations thereof are omitted here. The OS 123 executes the Java™ virtual machine 122 as subprograms.

The first CPU 124 performs processing in accordance with each of the Java™ virtual machine 122, the OS 123, the application acquisition program 121, and the application 100 acquired by execution of the application acquisition program 121.

The first RAM 125 stores the application program acquired by execution of the application acquisition program 121, as a class file, and stores the decrypted Java™ virtual machine 122. The first RAM 125 also stores data temporally when the first CPU 124 performs processing. The first RAM 125 is also used for passing data between the first CPU 124 and the second CPU 134 when the first CPU 124 requests the second CPU 134 to perform execution. The first RAM 125 includes, for example, a primary storage such as a SRAM and a DRAM.

The first ROM 126 stores an encrypted Java™ virtual machine 401 and so on. The first ROM 126 also stores data and programs in accordance with instructions given by the first CPU 124. The first ROM 126 is, specifically, a nonvolatile memory such as a flash memory and a hard disk.

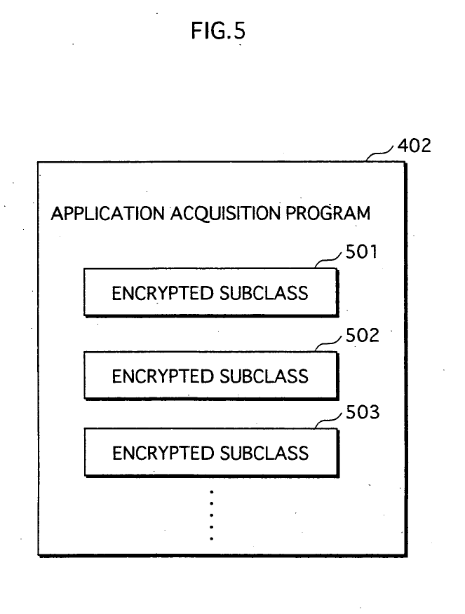

FIG. 4 illustrates an example of contents stored in the first ROM 126.

The first ROM 126 includes an encrypted Java™ virtual machine 401, an encrypted application acquisition program 402, an encrypted meta-information managing unit 403, and a startup class name 404.

FIG. 5 shows the structure of the application acquisition program 402.

The application acquisition program 402 includes a plurality of classes, such as subclasses 501 to 503. Each of the subclasses is encrypted.

The startup class name 404 is a name of a class that is initially executed when the Java™ virtual machine 122 is started up. In this embodiment, it is assumed that the subclass 501 is designated as the encrypted startup class name 404. Note that the first ROM 126 may store data not illustrated in FIG. 4.

The following describes components of the secure execution unit 130.

The meta-information managing unit 131 manages meta-information included in a class loaded in the Java™ virtual machine 122, refers to and processes the meta-information in accordance with instructions given by the bytecode interpreter 201, and provides the results of the processing. The meta-information managing unit 131 is described later in detail.

The Java™ virtual machine loader 132 performs processing for enabling the first CPU 124 to execute the Java™ virtual machine 122 when the application execution device 110 is powered on. The Java™ virtual machine loader 132 is described later in detail.

The decryption unit 133 is a program that decrypts encrypted information (e.g. application, the Java™ virtual machine 122 and so on) stored in the first RAM 125 or the second RAM 126, and writes the decryption-resultant information to the first RAM 125. Any algorithm may be used for the encryption.

The key for the above-described decryption is a decryption key 701 stored in the second ROM 136.

The second CPU 134 performs processing in accordance with the each of the meta-information managing unit 131, the Java™ virtual machine loader 132 and the decryption unit 133.

The second RAM 135 stores the class structure information set 301, the constant pool 302 and the class ID correspondence table, which are descried later. The second RAM 135 is also used for temporally storing data when the second CPU 134 performs processing.

The second RAM 135 is structured with a DRAM, a SRAM or the like, and only accessible by the second CPU 134. The first CPU 124 can not read or write information stored in the second RAM 135. The second RAM 135 may be mounted in the CPU 134.

A program executed by the normal execution unit 120, such as the Java™ virtual machine 122, and a program executed by the secure execution unit 130, such as the meta-information managing unit 131, work together. Therefore, it is necessary to exchange information between them.

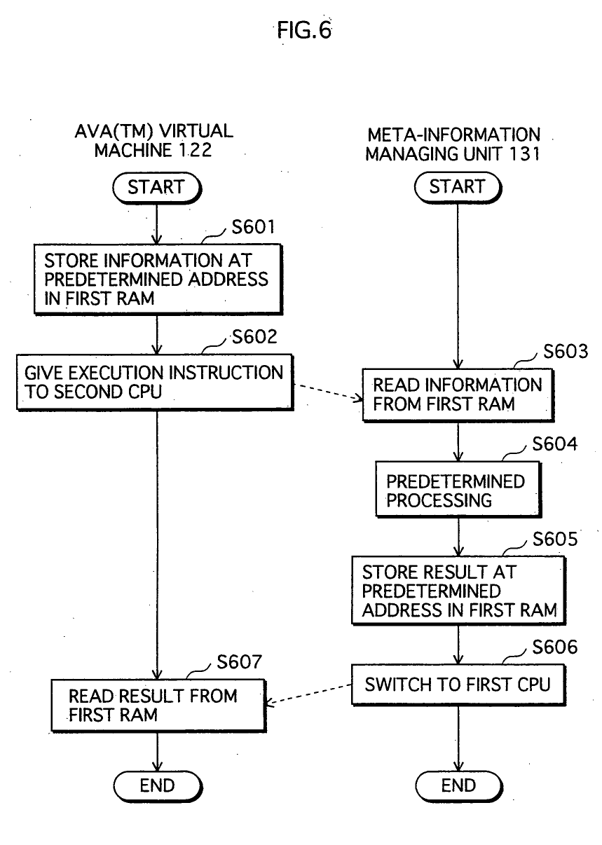

FIG. 6 is a flowchart showing operations performed when the Java™ virtual machine 122 gives an instruction to, for example, the meta-information managing unit 131.

As FIG. 6 shows, the Java™ virtual machine 122 stores information to be given to the meta-information managing unit 131, at a predetermined address in the first RAM 125 (S601). Next, the Java™ virtual machine 122 instructs, via the first CPU 124, the second CPU 134 to execute the meta-information managing unit 131 (S602). The meta-information managing unit 131 reads the data stored by the Java™ virtual machine 122 in Step S601 from the predetermined address in the first RAM 125 (Step S603), and performs predetermined processing using the data (Step S604).

Next, the meta-information managing unit 131 writes the processing result acquired in S604 at a predetermined address in the first RAM 125 (S605). Then, the meta-information managing unit 131 instructs, via the second CPU 134, the first CPU 124 to execute the Java™ virtual machine 122 (S606). Next, the Java™ virtual machine 122 reads the result of the processing performed by the meta-information managing unit 131 in S604 from the predetermined address in the first RAM 125.

With the operations described above, it is possible to exchange information by instructing a program executed by the secure execution unit 130 to perform processing based on information that the first CPU 124 can not directly refer to.

The second ROM 136 is structured with a read-only nonvolatile memory, and ensures that only the second CPU 134 can read information stored in the second ROM 136.

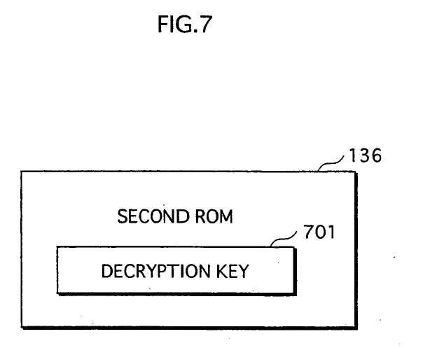

FIG. 7 shows an example of information stored in the second ROM 136.

The second ROM 136 shown in FIG. 7 stores a decryption key 701 for decrypting the Java™ virtual machine 401 and the subclasses 501 to 503 included in the application acquisition program 402, which are stored in the first ROM 126. In this embodiment, it is assumed that only the decryption key 701 is used for decrypting the Java™ virtual machine 401, the application acquisition program 402 and the startup class name 404. However, the present invention is feasible if different keys are used. Note that the second ROM 136 may store data not illustrated in FIG. 7.

The decryption key 701 is used for decrypting an encrypted decryption key for decrypting the encrypted application 100 acquired by the application acquisition program 121. The decryption key used for decrypting the application 100 is also stored in the second ROM 136.

In this embodiment, the application execution device 110 includes two CPUs. However, a single CPU may virtually work as if it includes two CPUs by switching operation modes. A CPU named “La Grande” manufactured by the Intel corp. is an example of CPUs that can change operation modes. This CPU has two operation modes, namely a normal mode and a secure mode, and it is designed such that a program that runs in the normal mode can not wiretap or temper a program that runs in the secure mode. CPUs having such a function are announced by the ARM Ltd and the AMD Inc.

Note that in this embodiment, the meta-information managing unit 131, the Java™ virtual machine loader 132 and the decryption unit 133 are programs executed by the second CPU 134. However, an LSI may realize functions thereof.

The first RAM 125 and the second RAM 135 may be realized by virtually assuming a single RAM as two RAMs. In the same manner, the first ROM 126 and the second ROM 136 may be realized by virtually assuming a single ROM as two ROMs.

All or part of the secure execution unit 130 may be realized as hardware. If this is the case, the data communication between the first CPU 124 and the second CPU 134 are performed with encryption, to protect data against wire tapping by a third party. This is realized by encrypting data when transmitting data through a data bus (not illustrate) between the two CPU, and decrypting the data after the data is received.

The secure execution unit 130 may be a device that is detachable from the application execution device 110, such as a smart card and an IC card. The smart card and the IC card are well-known art where a CPU, a memory and a security circuit are included within the card. Their detailed explanations are omitted here. In this case, the data communication between the normal execution unit 120 and the secure execution unit 130 is performed with use of the SAC (Secure Authenticated Channel) technique or the like to prevent tampering by a third party. The SAC is a well known technique that is used for securely performing a mutual authentication between an IC card and an external device, and securely sharing an encryption key.

The software of the secure execution unit 130 may be protected by anti-tamper software technology.

Next, the following describes a method used by the application execution device 110 to execute the Java™ application while protecting the application against wiretapping and tampering.

When the Java™ application execution unit 110 is powered on, the first CPU 124 starts up the OS 123. Upon being started up, the OS 123 instructs, via the first CPU 124, the second CPU 134 to load the Java™ virtual machine loader 132. The Java™ virtual machine loader 132 started up by the second CPU 134 loads the Java™ virtual machine 122 to the first RAM 125, and the meta-information managing unit 131 to the second RAM 135 respectively, in accordance with a certain procedure.

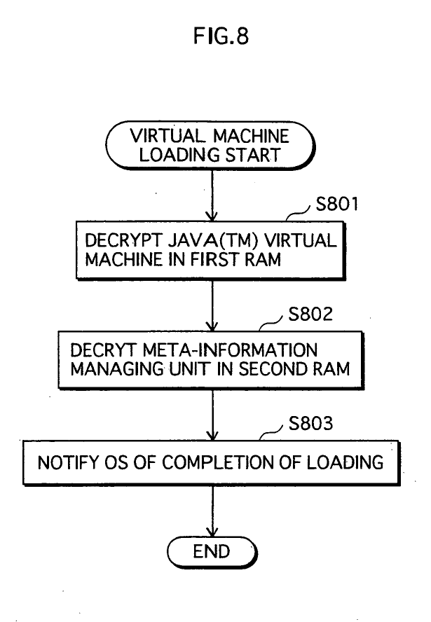

FIG. 8 shows procedures for loading the Java™ virtual machine 122 and the meta-information managing unit 131.

As FIG. 8 shows, in Step S801, the Java™ virtual machine loader 132 decrypts, in the first RAM 125, the Java™ virtual machine 401 stored in the first ROM 126 by using the decryption unit 133.

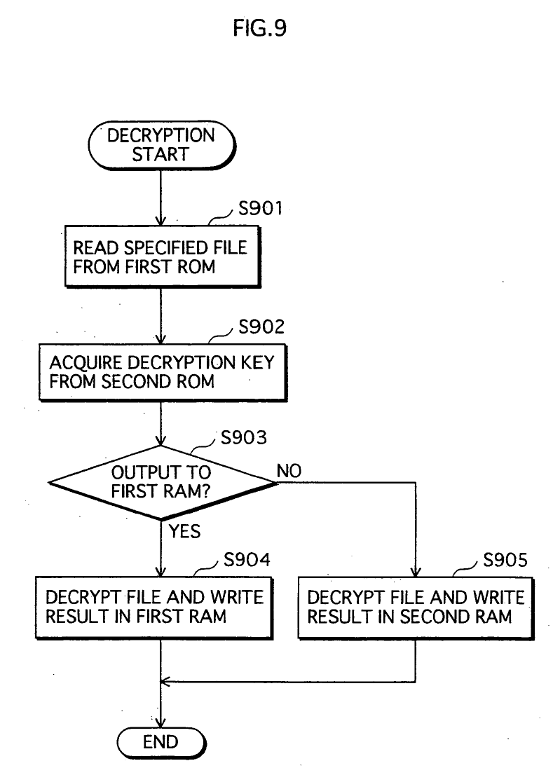

FIG. 9 shows procedures performed by the decryption unit 133 to decrypt the encrypted Java™ virtual machine loader 401.

As FIG. 9 shows, the decryption unit 133 reads the encrypted Java™ virtual machine 401 stored in the first ROM 126, via the second CPU 133 (Step S901).

The decryption unit 133 acquires the decryption key 701 from the second ROM 136 (Step S902), and determines the output destination of the decryption result of the Java™ virtual machine 401 (Step S903). If the output destination is the first RAM 125, the decryption unit 133 stores the decrypted Java™ virtual machine 122 in the first RAM 125 via the second CPU 134 (S904). If the output destination is the second RAM 135, the decryption unit 133 stores the decrypted Java™ virtual machine 122 in the second RAM 135 via the second CPU 134 (Step S905).

Again, in FIG. 8, the Java™ virtual machine loader 132 instructs the decryption unit 133 to decrypts, in the second RAM 135, the meta-information managing unit 404 stored in the first ROM 126 (S802). The Java™ virtual machine loader 132 notifies the OS 123 of the completion of the loading (Step S803).

Upon receiving the loading completion notification from the Java™ virtual machine loader 132, the OS 123 executes the Java™ virtual machine 122. When the execution of the Java™ virtual machine 122 is started, the class loader 202 is called. The class loader 202 refers to the startup class name 404 stored in the first ROM 126 shown in FIG. 4, and loads a class specified by the startup class name 404.

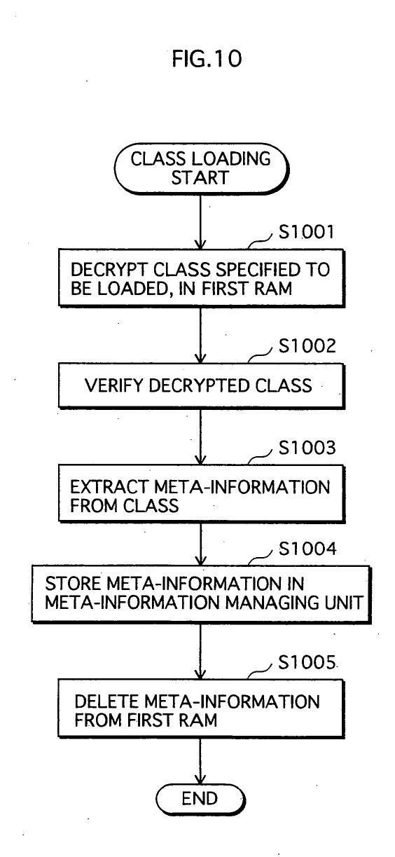

FIG. 10 is a flowchart showing processing procedures performed by the class loader 202 to load the subclass 501. This flowchart shows, as an example, the case where the subclass 501 of the application acquisition program 402 is designated.

Firstly, the class loader 202 instructs the decryption unit 133 to decrypts the encrypted subclass 501 stored in the first ROM 126 (S1001). Next, the class loader 202 instructs the verifier 203 to verify the decrypted subclass in the first RAM 125 (s1002). The class loader 202 extracts the meta-information (the class structure information set 301 and the constant pool 302) from the decrypted subclass in the first RAM 125 (S1003). After the extraction, the class loader 202 deletes the meta-information from the subclass, writes the meta-information in the first RAM 125, and calls the meta-information managing unit 131 (Step S1004). The meta-information managing unit 131 reads the meta-information from the first RAM 125 and copies the meta-information to the second RAM 135. When the meta-information managing unit 131 finishes copying of the meta-information, the class loader 202 deletes the meta-information from the first RAM 125 (S1005).

As described above, the class loader 202 performs such processing not only on the application acquisition program but also on the calls of the application acquired by the application acquisition program 121 in order to store the meta-information of the class only in the second RAM 135 which is secure.

With the stated structure, it is possible to store the meta-information of the class in an area that can not be read with a debugger or the like while the application is executed.

Next, the following describes example processing executed by the bytecode interpreter 201 and the meta-information managing unit 131 while the class is protected against wiretapping and tampering. Note that since the structure of the class and the operations of the bytecode interpreter 201 are described in the “Java™ Virtual Machine Specification” in detail, only the part closely relating to this embodiment is briefly explained here.

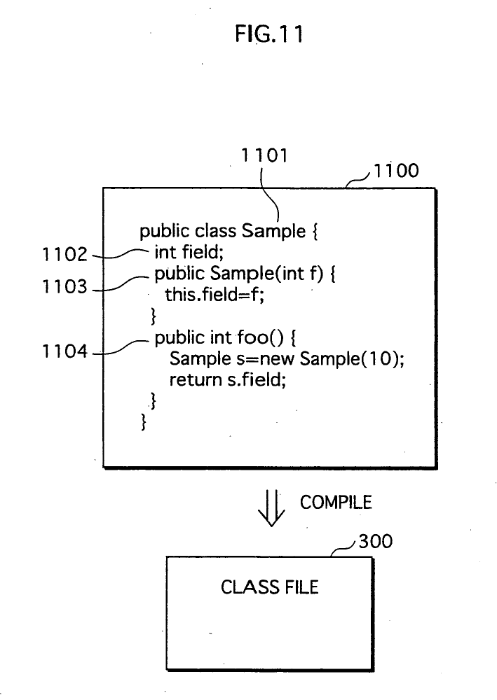

FIG. 11 is an example of a class file described in the Java™ language.

A class name 1101 is a name of the class, and in this sample, the class name is “Sample”.

A field 1102 is a filed defined by the Sample class. The field 1102 can be used as an area for storing a value of a calculation result at a time when a method is executed. A method 1103 and a method 1104 are methods defined in the Sample class. Note that a method is for defining processing performed by the class.

A source file 1100 which defines a class in the Java™ language is to be converted to a class file 300 by the Java™ compiler. The class file 300 resultant from the conversion includes the class structure information set 301, a constant pool 302 and a bytecode 303.

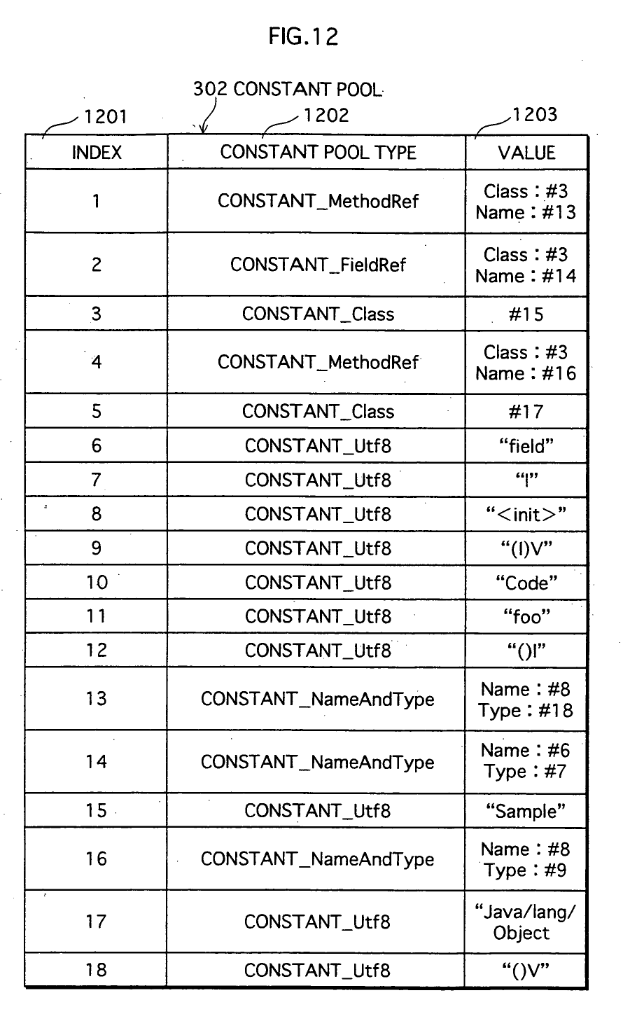

FIG. 12 shows a constant pool 302 of the class file 300 compiled from the source file 1100.

A column 1201 is an index showing entry numbers of the constant pools 302. This index is used for referring to the constant pools. A column 1202 shows a type of each constant pool. The type of the constant pool is determined in accordance with the type of information to be recorded. The column 1203 shows the value of each constant pool.

For example, the index 1 represents a reference to a class declared in the class of the index 3 and a reference to a method indicated by the index 13. A CONSTANT_Class of the index 3 is a reference to a class. The index 3 is a reference to a class whose name is indicated by the index 15, and CONSTANT_Utf8 of the index 15 indicates names of a class, a method and a field. The index 15 indicates, for example, a class name “Sample”. A CONSTANT_NameAndType of the index 13 indicates a reference to names of a method and a filed, and a type descriptor. The type descriptor represents a field type, a method argument and a return value type by a character string. The index 13 indicates, for example, the constant pool 302 has a name “index 8” and a type descriptor “index 18”. Their values are respectively “<init>” and “( )V”. In other words, the index 1 indicates a reference to method whose name is “<init>” and the type descriptor is “( )V”. A CONSTANT_FieldRef of the index 2 indicates that the constant pool 302 indicates a reference to a field. The index 2 refers to a field that is defined in the class “Sample” and whose name and type descriptor are “field” and “I” respectively.

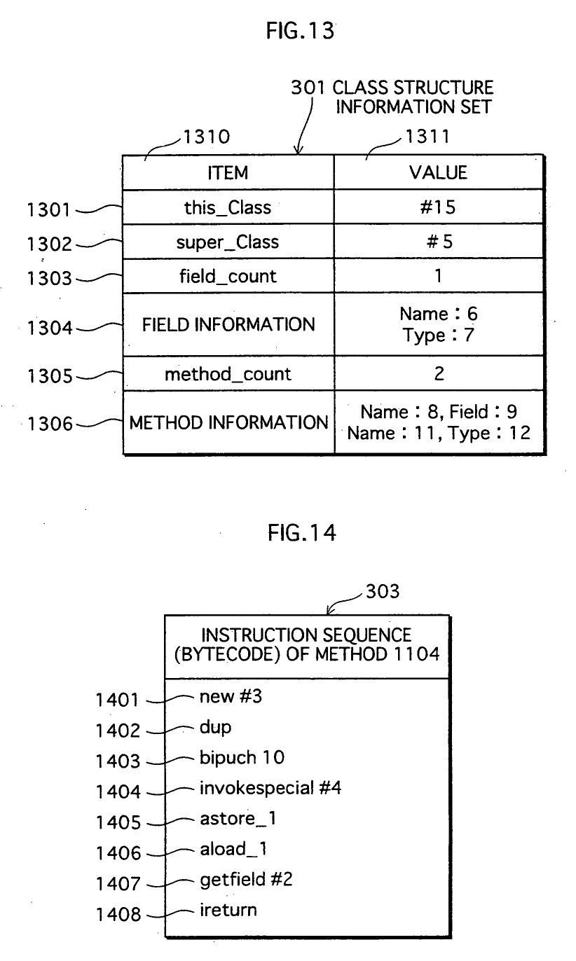

FIG. 13 shows a part of the class structure information set 301 of the class 1100. A this_class 1301 indicates a reference to a name of the class 1100. The name of the class is recorded at the index 15 of the constant pool 302. A super_class 1302 is a super class of the class 1100. A field_count 1303 indicates the number of fields defined in the class 1100. A field is an area that can store a processing result of a method. Field information 1304 stores a name of the field defined in the class 1100 and a access right. A method_count 1305 indicates the number of methods defined in the class 1100. Method information 1306 stores a name of a method defined in the class 1100, an address of a bytecode, and so on.

FIG. 14 shows a bytecode 303 of a method 1104 defined in the class 1100. The bytecode 303 accesses classes, fields and methods, using the constant pool 302. For example, the instruction 1401 refers to the constant pool 302 of the index 3.

When executing the bytecode 303, if there is an instruction referring to the constant pool 302, in other words, if there is an instruction specifying the index of the constant pool 302 by the sign “#” in FIG. 14, the bytecode interpreter 201 requests the meta-information managing unit 131 to perform a constant pool resolution, and processes the instruction using information acquired by the constant pool resolution. Here, the constant pool resolution is processing for finding out at which address in the first RAM 125 the class, the field, and the method represented by the character string in the constant pool 302.

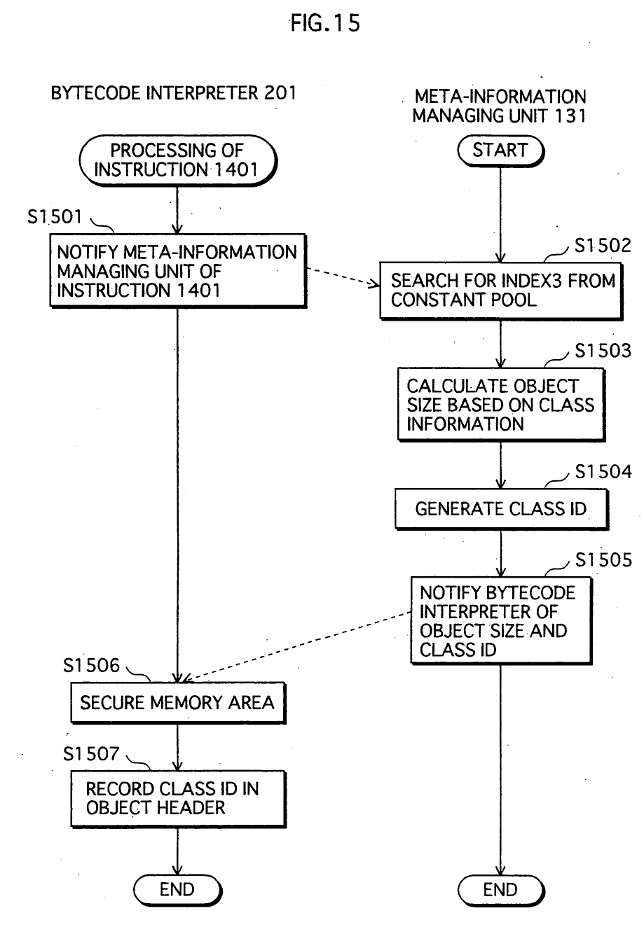

FIG. 15 is a flowchart showing execution of the instruction 1401 shown in FIG. 14.

In FIG. 15, the bytecode interpreter 201 fetches the instruction 1401. The instruction 1401 is an instruction for generating a class-type object stored at the location of the index 3 of the constant pool 302. Since the constant pool 302 is stored in the second RAM 135, the bytecode interpreter 201 can not access the constant pool 302. Accordingly, the bytecode interpret 201 notifies the meta-information managing unit 131 of the instruction 1401 (S1501). The meta-information managing unit 131 reads the instruction 1401, and searches for the constant pool 302 stored in the second RAM 135 from the index 3 referred by the instruction 1401 (S1502). As a result, the class name “Sample” is to be acquired in the embodiment.

Next, the meta-information managing unit 131 calculates the size of the object based on the class structure information set 301 of the “Sample” class (S1503). Here, the object size can be calculated by the number of the field and the type descriptor declared in the class. For example, the “Sample” class has one int-type filed. Therefore, the object size is 4 bytes.

Next, the meta-information managing unit 131 generates a class ID representing the “Sample” class (S1504). The class ID is information used for identifying from which class the object is generated. The class ID is realized using a 32-bit integer number. The meta-information managing unit 131 stores the correspondence relation between the class ID and the class structure information set 301 represented by the class name in the class ID correspondence table stored in the second RAM 134.

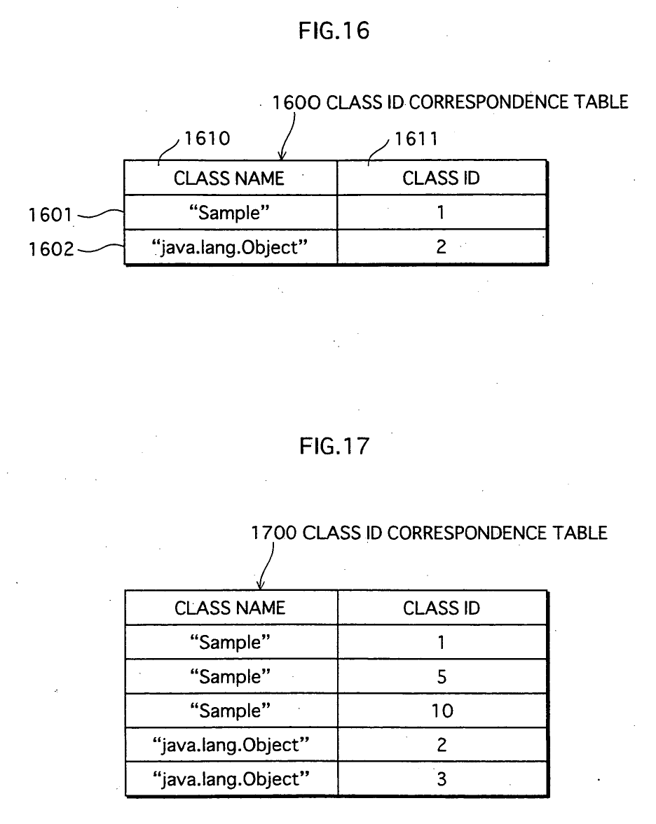

FIG. 16 shows an example of the class ID correspondence table. A column 1610 shows class names, and a column 1611 shows class IDs. For example, in a row 1601, it is shown that the class ID of the class structure information set 301 represented by the class name “Sample” is associated with a value “1”.

Again, in FIG. 15, the meta-information managing unit 131 stores the object size calculated in S1503 and the class ID generated in S1504 in the first RAM 125, and notifies the bytecode interpreter 201 of the object size and the class ID (S1505). Then, the bytecode interpreter 201 secures a memory area for the object size notified by the bytecode interpreter 201 (Step S1506), and records the notified class ID in the object header (S1507). The object header is an area for storing various types of information of the object.

By performing the above-described operations, the bytecode interpreter 201 can execute the instruction 1401 without acquiring the meta-information. In such a case, a malicious third party can not wiretap the contents in the constant pool 302, because the constant pool 302 is stored in the second RAM 135. Also, even if the malicious third party wiretaps the communication between the bytecode interpreter 201 and the meta-information managing unit 131, the malicious third party can acquire only the index of the constant pool 302 and the object size to be secured, and the contents of the constant pool does not leak. In other words, the contents of the constant pool 302 are protected against the malicious third party.

Note that, in the class ID correspondence table 1600, the correspondence between the class IDs and the class structure information sets 301 is not limited to one-to-one.

FIG. 17 shows an example in which one class structure information set 301 corresponds to a plurality of class IDs. With this structure, when a tool such as a debugger wiretaps the first RAM 125, it becomes difficult for the tool to analyze which object corresponds to which class.

The instructions 1402 to 1403 do not includes a reference to the constant pool 302. Therefore, the bytecode interpreter 201 can executes the instructions without calling the meta-information managing unit 131. The instruction 1404 includes a reference the constant pool 302. The instruction 1404 is for calling the bytecode represented by the class name and the method name stored at the location of the index 4 of the constant pool 302 stored in the second RAM 135.

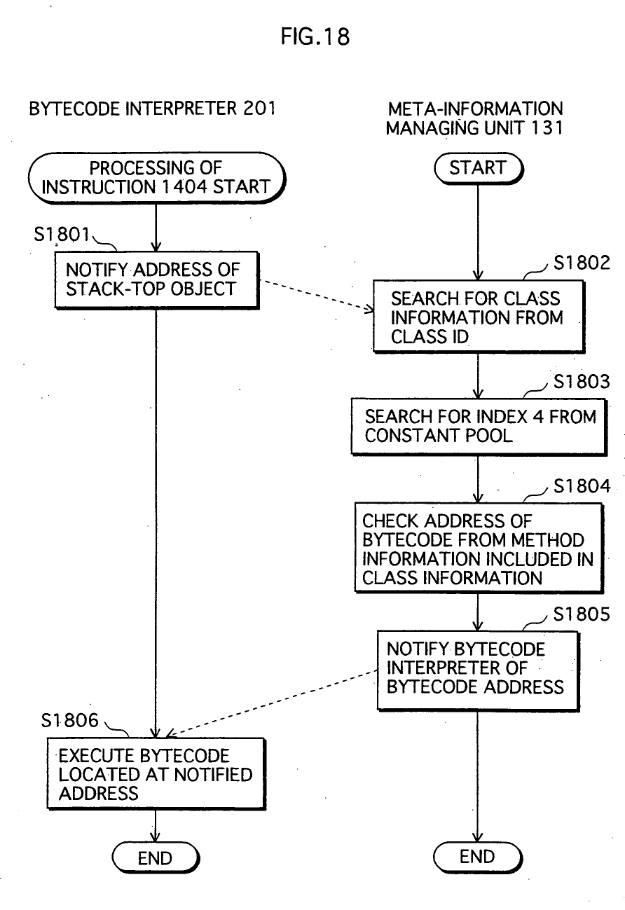

FIG. 18 is a flowchart showing operations performed by the bytecode interpreter 201 to execute the instruction 1404.

The bytecode interpreter 201 fetches the instruction 1404, and notifies the meta-information managing unit 131 of the instruction 1404 and the address of a receiver object (S1801).

Here, the receiver object is an object that is a target of the method to be executed. In the Java™ language, the method is performed in a field stored in the receiver object. The meta-information managing unit 131 searches for a class ID stored in the object header of the receiver object from the class ID correspondence table 1600 stored in the second RAM 134, and searches for the class structure information set 301 corresponding to the class ID (S1802). As FIG. 16 shows, since the class ID is “1”, the class structure information set 301 shown in FIG. 13 is to be found.

Next, the meta-information managing unit 131 searches for the index 4 from the constant pool 302, and acquires the method name “<Init>” and the type descriptor “(I)V” (S1803). The meta-information managing unit 131 searches for a method having the method name and the type descriptor found by the search performed in S1803 from the method information 1306 included in the class structure information set 301 found by the search in Step S1802, and acquires the bytecode address of the method (S1804). The meta-information managing unit 131 notifies the interpreter 201 of the bytecode address acquired in S1804 (S1805). The bytecode interpreter 201 executes the instruction at the bytecode address notified from the meta-information managing unit 131 (S1806).

By performing the above-described operations, the bytecode interpreter 201 can execute the instruction 1404 without acquiring the meta-information. In such a case, a malicious third party can not wiretap the contents in the constant pool 302, because the constant pool 302 is stored in the second RAM 135. Also, even if the malicious third party wiretaps the communication between the bytecode interpreter 201 and the meta-information managing unit 131, the malicious third party can acquire only the index of the constant pool and the bytecode address to be executed the next, and the contents of the constant pool does not leak. In other words, the contents of the constant pool are protected against the malicious third party.

The instructions 1405 and 1406 do not includes a reference to the constant pool 302. Therefore, the bytecode interpreter 201 can execute the instructions without calling the meta-information managing unit 131.

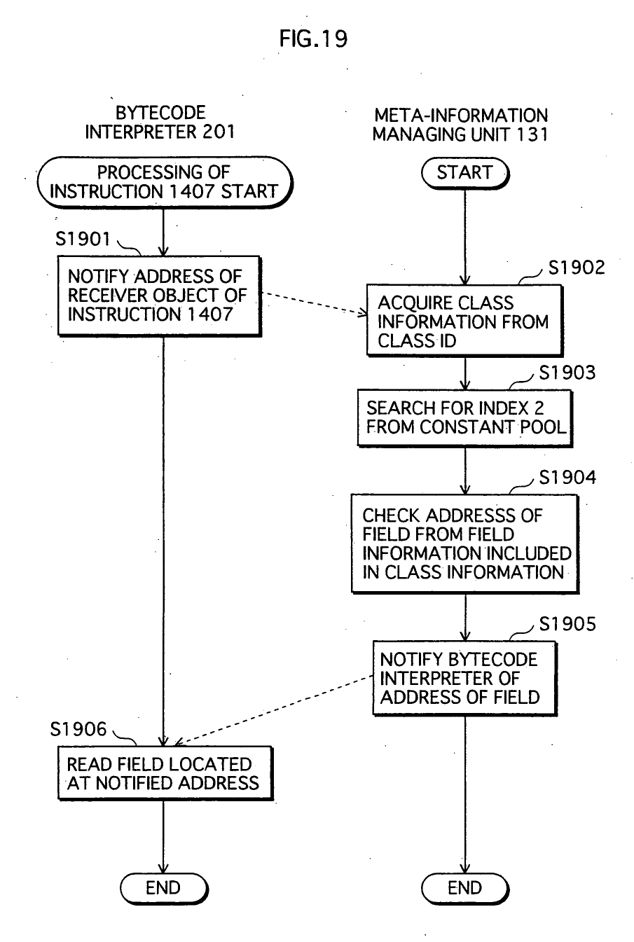

The instruction 1407 includes a reference to the constant pool 302. The instruction 1407 is for read the field represented by the class name and the filed name stored at the location of the index 2 of the constant pool 302 stored in the second RAM 135. Since the constant pool 302 is stored in the second RAM 135, the bytecode interpreter 201 can not access the constant pool 302. FIG. 19 is a flowchart showing operations performed by the bytecode interpreter 201 to execute the instruction 1407.

Upon fetching the instruction 1407, the bytecode interpreter 201 calls the meta-information managing unit 131, and notifies the meta-information managing unit 131 of the instruction 1407 and the address of the object that is at the top level in the Java™ stack of the instruction 1407 and is to be executed immediately (S1901).

Here, regarding the Java™ stack, see the “Java™ Virtual Machine Specification”.

The meta-information managing unit 131 searches for the class ID stored in the object header of the notified object from the class ID correspondence table 1600 stored in the second RAM 134, and searches for the class structure information set 301 corresponding to the class ID (S1902). In this embodiment, the class ID is “1”. Therefore, the class structure information set 301 is to be found by the search.

The meta-information managing unit 131 searches for the index 2 from the constant pool 302, and acquires the field name “field” and the type descriptor “I” (S1903). The meta-information managing unit 131 searches for the filed having the field name and the type descriptor found by the search performed in S1903, from the field information 1304 included in the class structure information set 301 found by the search performed in S1902, and acquires the address of the field (S1904). The meta-information managing unit 131 stores the filed address acquired in S1904 in the first RAM 125, and notifies the bytecode interpreter 201 of the address (S1905). The bytecode interpreter 201 reads data at the field address notified by the meta-information managing unit 131 (S1906).

By performing the above-described operations the bytecode interpreter 201 can execute the instruction 1407 without acquiring the meta-information. In such a case, a malicious third party can not wiretap the contents in the constant pool 302, because the constant pool 302 is stored in the second RAN 135. Also, even if the malicious third party wiretaps the communication between the bytecode interpreter 201 and the meta-information managing unit 131, the malicious third party can acquire only the index of the constant pool 302 and the address of the field from which data is to be read, and the contents of the constant pool 302 does not leak. In other words, the contents of the constant pool 302 are protected against the malicious third party.

As described above, the meta-information (the class structure information set 301 and the constant pool 302) is stored only in the second RAM 134 which is not accessible by a debugger. Therefore, even if a malicious third party attempts to make an unauthorized copy of the Java™ application with use of a tool such as a debugger, the malicious third party cannot acquire the meta-information. Also, even if the third party attempts to wiretap and tamper data while the Java™ application is being executed, it is extremely difficult to attack the application because the third party can not read the meta-information and can not know which method and data is those the third party wants to tap and tamper.

Although it is assumed in the above-described embodiment that the application acquisition program 121 and the Java™ virtual machine 122 are realized as software executed by the first CPU 124, they may be realizes as hardware such as an LSI as a matter of course.

### The Second Embodiment

In the first embodiment above, the class loader 202 and the verifier 203 are executed by the normal execution unit 120 as subprograms of the Java™ virtual machine 122. Accordingly, if the first RAM 125 is tampered between the completion of S1001 shown in FIG. 10 for the class loading and S1005 with use of a tool such as a debugger, the meta-information might leak. In the second embodiment, this problem is solved by executing the class loader 202 and the verifier 203 by the secure execution unit 130.

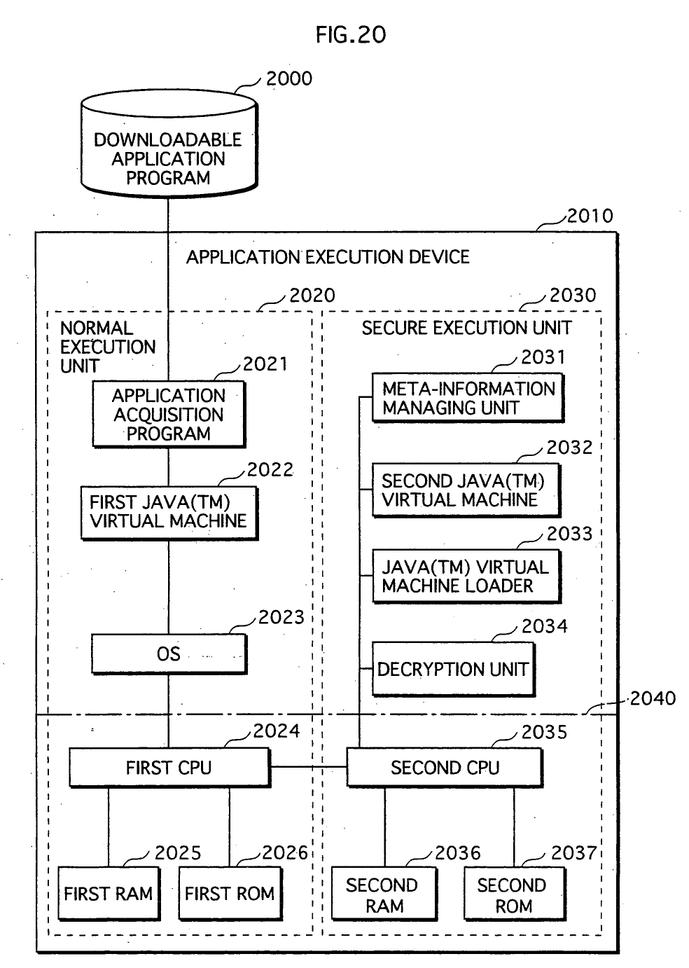

FIG. 20 is a block diagram showing the structure of an application execution device according to the second embodiment.

Among components of an application execution device 2010 of this embodiment, a first Java™ virtual machine 2022, a second Java™ virtual machine 2032 and the a decryption unit 2034 are different from the components of the application execution device 110. The other components are the same as those of the first embodiment. Therefore, explanations thereof are omitted here.

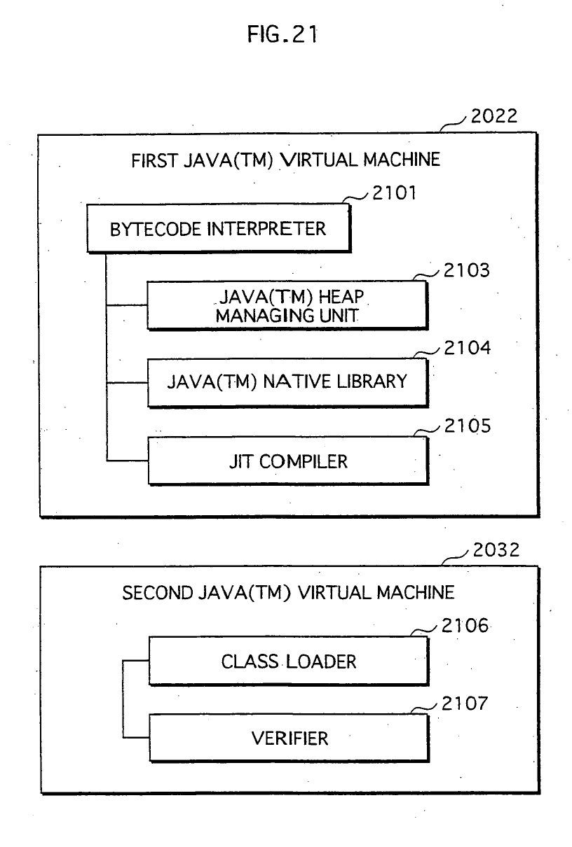

FIG. 21 shows the structure of subprograms included in each of the first Java™ virtual machine 2022, the second Java™ virtual machine 2032.

A class loader 2106 and a verifier 2107 are subprograms of the second Java™ virtual machine 2032 to be executed by a secure execution unit 2030.

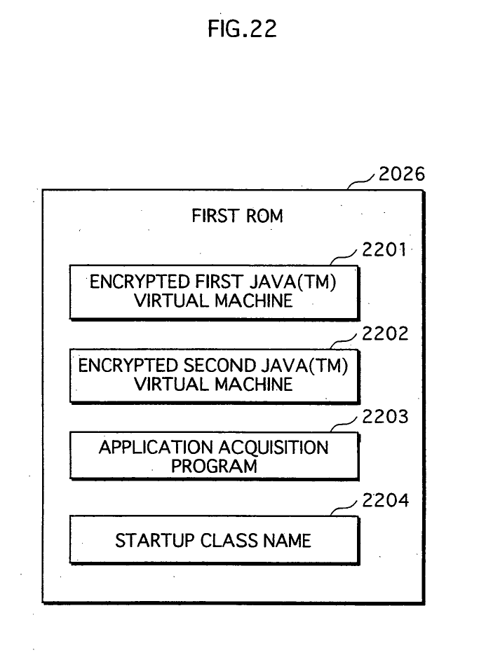

Also, as FIG. 22 shows, a first ROM 2026 stores the first Java™ virtual machine 2201 and the second Java™ virtual machine 2202.

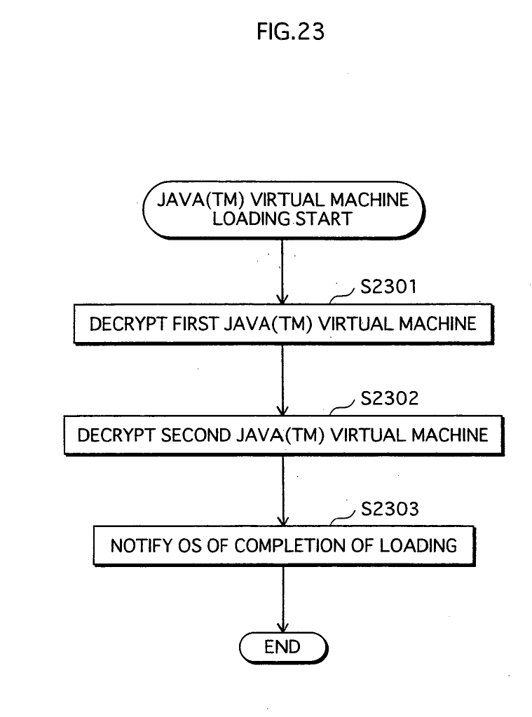

FIG. 23 is a flowchart showing operations performed by a Java™ virtual machine 2033 to load the first Java™ virtual machine 2022 and the second Java™ virtual machine 2032.

In S2301 of FIG. 23, the Java™ virtual machine loader 2033 instructs the decryption unit 2034 to decrypt the first Java™ virtual machine 2201 and output the result of the decryption to the first RAM 2026.

The Java™ virtual machine loader 2033 also instructs the decryption unit 2034 to decrypts the second Java™ virtual machine 2202 and output the result of the decryption to the second RAM 2036 (S2302). Finally, the Java™ virtual machine loader 2033 notifies an OS 2023 of the completion of the load (S2303).

The Java™ virtual machine can be loaded by these operations.

The loading of the class is the same as that of the first embodiment, except for that the class loader 2106 and the verifier 2107 are executed by the secure execution unit 2010. Therefore, the explanation thereof is omitted here. Also, the execution of the class is the same as that of the first embodiment. Therefore, the explanation thereof is omitted here.

With the stated structure, even during the loading of the class, it is possible to protect the meta-information against wiretapping and tampering by a tool such as a debugger.

In the first and the second embodiments, the application execution devices that execute the Java™ application are described. However, the present invention is also applicable to applications written in other languages having meta-information. For example, in the C# language standardized by the ECMA, an intermediate language called CIL (Common Intermediate Language) (corresponding to the bytecode of the Java™ language) is executed by a virtual machine called CLI (Common Language Infrastructure) (corresponding to the Java™ virtual machine of the Java™ virtual machine language). The meta-information of the C# language is defined in the Partition II of the ECMA-355 standard.

In the first and the second embodiments, all the meta-information sets included in the class file are stored only in the second RAM 135. However, some of the meta-information sets may be stored in the first RAM 125. If this is the case, although the information stored in the first RAM 125 can be tampered by analyzed by a tool such as a debugger, the execution speed of the application can be accelerated because the interactions between the normal execution unit 120 and the secure execution unit 130 can be reduced.

It is impossible to restore a complete class based on some of the meta-information sets. However, it is possible to restore a complete class by estimating the other meta-information sets based on the obtained meta-information sets. How many of the meta-information sets should be kept secret can be determined based on the protection level required for the execution program.

### INDUSTRIAL APPLICABILITY

An application execution device according to the present invention is capable of protecting an application against wiretapping and tampering while the application is executed, by hiding meta-information necessary for executing or analyzing the application in a secure execution unit which is not easily wiretapped or tampered. Therefore, the application execution device according to the present invention can be used in businesses relating to download and distribution of applications, in order to protect rights of contents developers.

1. An application execution device that executes each of classes included in an acquired application, comprising:
a meta-information storing unit operable to store meta-information included in a class file;
an instruction sequence storing unit operable to store an instruction sequence included in the class file;
an instruction execution unit operable (i) to execute an instruction if the instruction does not refer to any information, and (ii) if the instruction refers to first information, to submit a request and execute the instruction using second information provided in response to the request; and
a meta-information execution unit operable to generate the second information based on the meta-information in response to the request, and provide the instruction execution unit with the second information, wherein
only the meta-information execution unit is capable of reading the meta-information stored in the meta-information storing unit, and the meta-information execution unit accepts only a request from the instruction execution unit.

2. The application execution device of claim 1, wherein
the meta-information storing unit stores a constant pool describing an index, a constant pool type and a value, and a class structure information describing an item and a value,
the instruction sequence storing unit stores a bytecode of a method defined in the class file, and
if the instruction execution unit executes an instruction included in a bytecode that designates the index of the constant pool as the first information, the meta-information execution unit generates the second information with reference to the constant pool and the class structure information, in accordance with a type of the instruction.

3. The application execution device of claim 2, wherein
if the bytecode to be executed by the instruction execution unit represents a generation of a new object, the meta-information execution unit searches for a constant pool type corresponding to the designated index from the constant pool, and generates a memory size with reference to the class structure information.

4. The application execution device of claim 2, wherein
if the bytecode to be executed by the instruction execution unit represents a call of the method, the meta-information execution unit searches for a constant pool type corresponding to the designated index from the constant pool, and generates an address of the method with reference to the class structure information.

5. The application execution device of claim 2, wherein
if the bytecode to be executed by the instruction execution unit represents a reference to a field of an object, the meta-information execution unit searches for a constant pool type corresponding to the designated index from the constant pool, and generates an address of the field with reference to the class structure information.

6. The application execution device of claim 1, wherein
the acquired application is encrypted, and
the application execution device further comprises
a decryption unit operable to decrypt the encrypted application, store decrypted instruction sequence in the instruction sequence storing unit, and store decrypted meta-information in the meta-information storing unit.

7. The application execution device of claim 6, wherein
the decryption unit uses a decryption key to decrypt the application, the decryption key being stored in a key storing unit that does not accept a direct access from outside.

8. The application execution device of claim 1, wherein
the application is a Java™ application.

9. An application execution method used by an application execution device that executes each of classes included in an acquired application, the method comprising:
a meta-information storing step of storing meta-information included in a class file;
an instruction sequence storing step of storing an instruction sequence included in the class file;
an instruction execution step of (i) executing an instruction if the instruction does not refer to any information, and (ii) if the instruction refers to first information, submitting a request and executing the instruction using second information provided in response to the request; and
a meta-information execution step of generating the second information based on the meta-information in response to the request, and providing the instruction execution step with the second information, wherein.
only the meta-information execution step is capable of reading the meta-information stored by the meta-information storing step, and the meta-information execution step accepts only a request from the instruction execution step.
